(19) United States
(12) Patent Application Publication
(10) Pub. No.: US 2015/0117525 A1
(43) Pub. Date: Apr. 30, 2015

(54) APPARATUS AND METHOD FOR ENCODING IMAGE

(71) Applicant: Kabushiki Kaisha Toshiba, Minato-ku (JP)

(72) Inventors: Wataru ASANO, Yokohama (JP); Tomoya Kodama, Kawasaki (JP); Jun Yamaguchi, Kawasaki (JP); Akiyuki Tanizawa, Kawasaki (JP)

(73) Assignee: Kabushiki Kaisha Toshiba, Minato-ku (JP)

(21) Appl. No.: 14/461,624

(22) Filed: Aug. 18, 2014

(30) Foreign Application Priority Data
Oct. 25, 2013 (JP) 2013-222477

(51) Int. Cl. H04N 19/167; H04N 19/127

(52) U.S. Cl. CPC H04N 19/167; H04N 19/127
USPC 375/240.08

(57) ABSTRACT

According to an embodiment, an encoding apparatus includes a processor and a memory. The memory stores processor-executable instructions that, when executed by the processor, cause the processor to: divide an image included in an image group into a plurality of regions; calculate a priority for each of the regions on the basis of levels of importance of the regions; determine an order of processing for the regions on the basis of the corresponding priority; and encode the regions according to the determined order of processing.

### CROSS-REFERENCE TO RELATED APPLICATION

This application is based upon and claims the benefit of priority from Japanese Patent Application No. 2013-222477, filed on Oct. 25, 2013; the entire contents of which are incorporated herein by reference.

### FIELD

Embodiments described herein relate generally to an apparatus and a method for encoding an image.

### BACKGROUND

Conventionally, there is known a moving image (Video) encoding apparatus that divides an image into a plurality of regions such as slices or tiles, and encodes the image on a region-by-region basis. In such an encoding apparatus, the processing time for each region can be adjusted by moving boundaries between regions such as slices or tiles.

Meanwhile, the conventional encoding apparatus encodes a plurality of regions such as slices or tiles in a predetermined order. Therefore, in the conventional encoding apparatus, relatively important regions may be encoded later than regions not important. In such a case, there is a possibility that the conventional encoding apparatus may not be able to output high-quality encoded data when, for example, outputting to a transmission line or achieving real-time encoding.

### BRIEF DESCRIPTION OF THE DRAWINGS

FIG. 1 is a block diagram of an encoding apparatus according to a first embodiment;

FIG. 2 is a flowchart for the encoding apparatus according to the first embodiment;

FIG. 3 is a diagram illustrating a relationship between an image structure for prediction encoding and a group of images;

FIG. 4 is a diagram illustrating an example of a plurality of regions;

FIG. 5 is a diagram illustrating an image structure for multi-level prediction encoding;

FIG. 6 is a diagram illustrating an example of the order of processing of a plurality of regions;

FIG. 7 is a block diagram of an encoding apparatus according to a second embodiment;

FIG. 8 is a block diagram of an encoding apparatus according to a variant of the second embodiment;

FIG. 9 is a diagram illustrating a relationship between an image structure for prediction encoding and a processing target computer;

FIG. 10 is a flowchart for the encoding apparatus according to the second embodiment;

FIG. 11 is a diagram illustrating an example of estimated processing times for a plurality of regions;

FIG. 12 is a diagram illustrating an example of assigning a plurality of regions to process performing units;

FIG. 13 is a block diagram of an encoding apparatus according to a third embodiment;

FIG. 14 is a flowchart illustrating the flow of a process performed by the encoding apparatus according to the third embodiment; and

FIG. 15 is a hardware diagram of the encoding apparatuses according to the embodiments.

### DETAILED DESCRIPTION

According to an embodiment, an encoding apparatus includes a processor and a memory. The memory stores processor-executable instructions that, when executed by the processor, cause the processor to: divide an image included in an image group into a plurality of regions; calculate a priority for each of the regions on the basis of levels of importance of the regions; determine an order of processing for the regions on the basis of the corresponding priority; and encode the regions according to the determined order of processing.

### First Embodiment

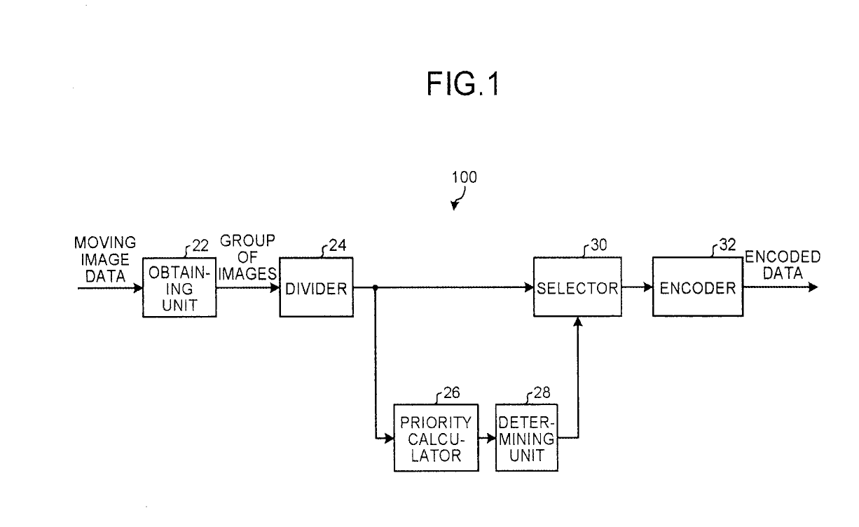

FIG. 1 is a diagram illustrating a block of an encoding apparatus 100 according to a first embodiment. The encoding apparatus 100 encodes moving image data in real time by a predetermined scheme, and thereby generates encoded data.

The encoding apparatus 100 includes an obtaining unit 22, a divider 24, a priority calculator 26, a determining unit 28, a selector 30, and an encoder 32. The obtaining unit 22 accepts, as input, moving image data from, for example, an imaging device, a playback device for a recording medium, or a broadcast signal receiving device. The obtaining unit 22 obtains a group of images including at least one image (e.g., a frame or a field) from the inputted moving image data. Then, the obtaining unit 22 supplies the obtained group of images to the divider 24. Note that the group of images may consist of a single image or may consist of a plurality of images.

The divider 24 divides each of the images included in the received group of images into a plurality of regions. The regions are the unit in which the encoder 32 at a subsequent stage performs encoding at once. For example, the regions are slices defined by a moving image encoding standard scheme (e.g., MPEG (Moving Picture Experts Group)-1, MPEG-2, MPEG-4, H.264/AVC, or the like). Alternatively, for example, the regions are tiles defined by MPEG-H HEVC/H.265.

The priority calculator 26 calculates priorities on a region-by-region basis, based on the level of importance of each region. As used herein, the level of importance is a parameter indicating the importance of the region in the moving image data. As an example, the level of importance is a parameter such as whether the region is a reference image, the features of the region, or the position in the image, or a value obtained by combining these parameters. In this example, the level of importance exhibits a higher value for higher importance. The priority calculator 26 calculates priorities such that the higher the level of importance the higher the value thereof.

The determining unit 28 determines the order of processing for each region, based on the priorities calculated on a region-by-region basis. The determining unit 28 determines the order of processing such that processing is performed earlier for a higher priority.

The selector 30 sequentially selects each of the plurality of regions divided by the divider 24, according to the order of processing determined by the determining unit 28, and supplies the selected regions to the encoder 32. The encoder 32 sequentially encodes the regions, according to the order in which the regions are selected by the selector 30. Namely, the encoder 32 encodes the regions in the order of processing determined by the determining unit 28.

As an example, the encoder 32 encodes each region by a scheme standardized by MPEG-1, MPEG-2, MPEG-4, H.264/AVC, H.265/HEVC, or the like, and thereby generates encoded data. The encoder 32 then sends the generated encoded data to a unit at a subsequent stage, according to the order of processing.

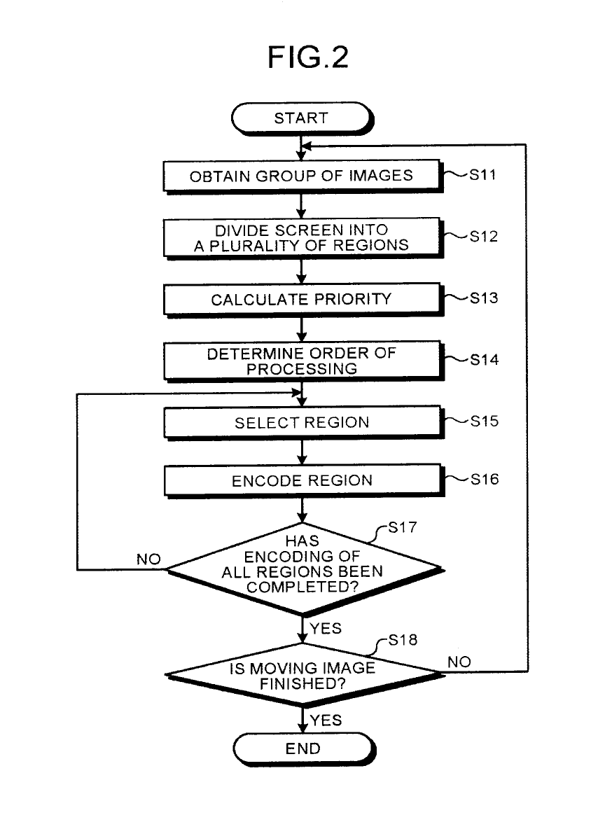

FIG. 2 is a flowchart illustrating the flow of a process performed by the encoding apparatus 100 according to the first embodiment. When input of moving image data starts, the encoding apparatus 100 starts the process from step S11.

First, at step S11, the obtaining unit 22 obtains a group of images from the moving image data. In this case, the obtaining unit 22 obtains a group of images including a single or a plurality of images with no reference relationship therebetween.

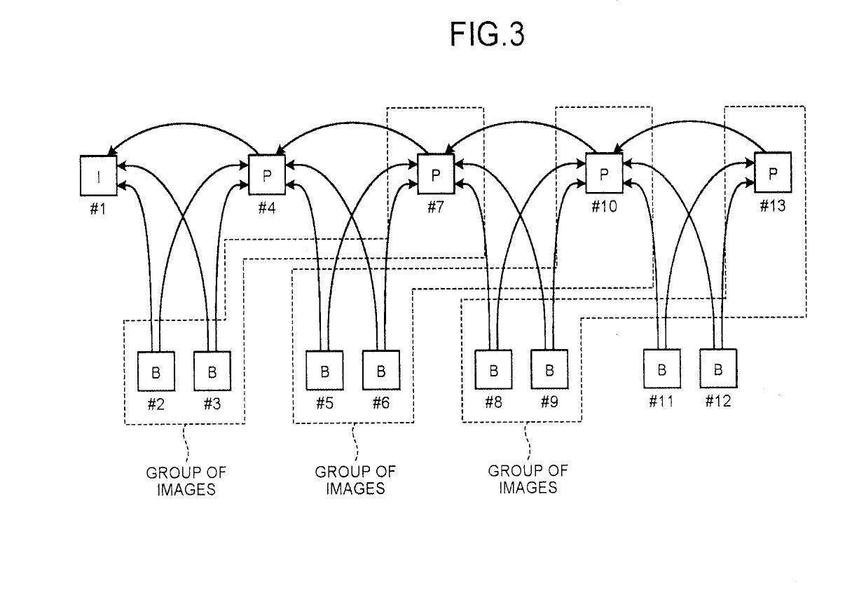

For example, it is assumed that a moving image data prediction structure is configured as illustrated in FIG. 3. Note that in FIG. 3 an arrow indicates a reference direction. Note also that in FIG. 3 the number following “#” indicates the order of display. In this case, as an example, the obtaining unit 22 obtains a set of images including a B picture (#2), a B picture (#3), and a P picture (#7), as a group of images. By thus obtaining images with no reference relationship therebetween as a group of images, the obtaining unit 22 can obtain one or more images that can be encoded in parallel with one another.

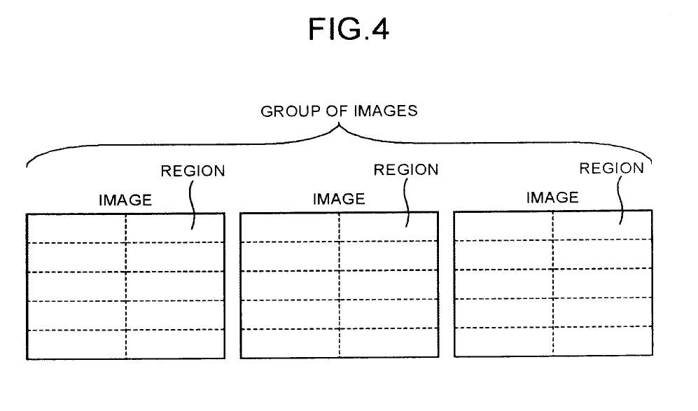

Subsequently, at step S12, the divider 24 divides each of the images included in the group of images into a plurality of regions. For example, as illustrated in FIG. 4, the divider 24 divides an image in slice units of a moving image encoding standard scheme. Alternatively, when encoding is performed by MPEG-H HEVC/H.265, the divider 24 may divide an image in tile units of MPEG-H HEVC/H.265.

Subsequently, at step S13, the priority calculator 26 calculates priorities of the respective plurality of regions, based on a parameter indicating the level of importance of each of the plurality of regions. In this case, the priority calculator 26 calculates priorities such that a region with a higher level of importance has a higher value of the priority.

As an example, the priority calculator 26 calculates a priority, based on whether an image including a target region is a reference image (an I picture or a P picture in FIG. 3). In this case, if the image including a target region is a reference image (an I picture or a P picture in FIG. 3), the priority calculator 26 sets a high priority, and if the image including a target region is not a reference image (a B picture in FIG. 3), the priority calculator 26 sets a low priority. Alternatively, as an example, if the image including a target region is an I picture, the priority calculator 26 may set the highest priority, and if the image including a target region is a P picture, the priority calculator 26 may set an intermediate priority, and if the image including a target region is a B picture, the priority calculator 26 may set the lowest priority. By this, the priority calculator 26 can calculate priorities, according to the influence exerted on other images.

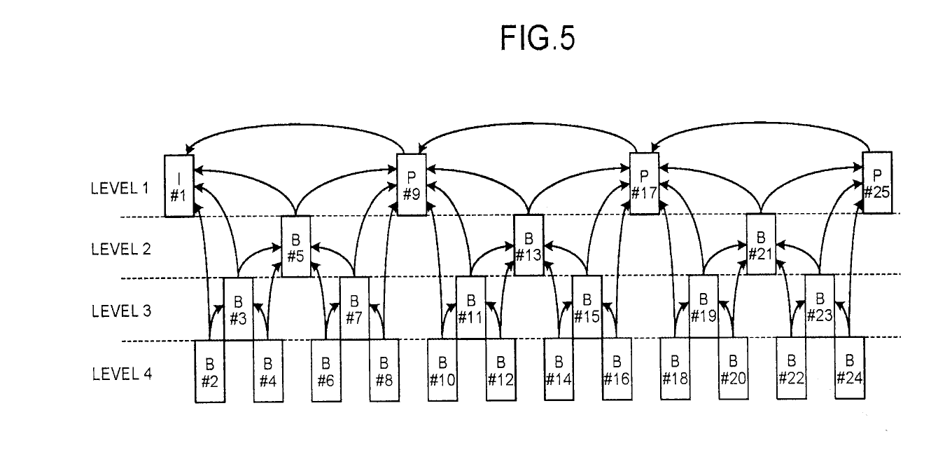

In addition, there is a case in which, for example, as illustrated in FIG. 5, encoding is performed using a multi-level hierarchical prediction structure where a B picture is referred to by other B pictures. In such a case, the priority calculator 26 may set a higher priority for images with a larger number of references (images at level 1 in FIG. 5), and may set the lowest priority for images not to be referred to (images at level 4 in FIG. 5). A reference image indicates an image to be referred to by other images. Even if the image is a B picture, if the B picture is referred to by other images, then the priority calculator 26 calculates a priority taking it into account.

Alternatively, as an example, the priority calculator 26 may calculate a priority, based on the features of a target region. For example, the priority calculator 26 may calculate a priority, based on the magnitude of activity in the target region or the magnitude of the amount of movement in the target region. In this case, the priority calculator 26 sets a high priority for large activity in the target region, and sets a low priority for small activity. In addition, the priority calculator 26 sets a high priority for a large amount of movement in the target region, and sets a low priority for a small amount of movement. By this, the priority calculator 26 can calculate a priority, according to how much the amount of image information included in the region is.

Alternatively, as an example, the priority calculator 26 may calculate a priority, based on the position of a target region in an image. For example, the priority calculator 26 may calculate a priority, according to the distance of a target region from the center of an image. In this case, the priority calculator 26 sets a higher priority for a target region closer to the center of the image. By this, the priority calculator 26 can set the priorities of regions with a high probability of being watched by a user, to a higher value than those of regions with a low probability of being watched by the user.

Alternatively, as an example, the priority calculator 26 may calculate a priority, based on whether an object included in a target region is a foreground or a background. As an example, the priority calculator 26 compares the distance from the eye point to an object with a reference distance to determine whether the object is a foreground or a background. In this case, the priority calculator 26 sets a high priority for when the object included in the target region is a foreground, and sets a low priority for when the object is a background. By this, the priority calculator 26 can set a higher priority for regions including a foreground with a high probability of being watched by the user than those of regions including a background with a low probability of being watched by the user.

Alternatively, as an example, the priority calculator 26 may calculate a priority, based on whether an object with a high probability of being watched by the user, such as a person, is included in a target region. As an example, the priority calculator 26 determines whether a person is included in a region, by performing a face detection process, etc. In this case, the priority calculator 26 sets a high priority for when the object included in the target region is an object with a high probability of being watched by the user, such as a person. By this, the priority calculator 26 can set a higher priority for regions including an object with a high probability of being watched by the user than those of other regions.

Furthermore, the priority calculator 26 may calculate a priority using a combination of the above-described plurality of determination elements. By this, the priority calculator 26 can more accurately calculate the priority of a target region.

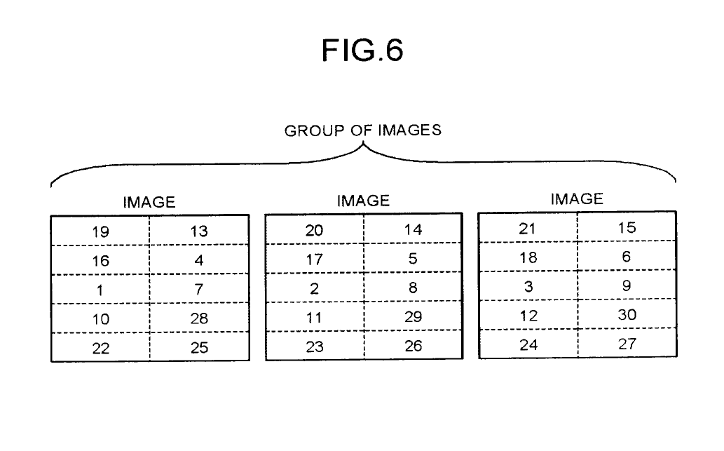

Subsequently, at step S14, the determining unit 28 determines the order of processing of the plurality of regions, based on the priorities calculated for the respective plurality of regions. The determining unit 28 determines the order of processing such that a region with a higher priority is given higher priority for being processed, i.e., processed in an earlier turn order. For example, as illustrated in FIG. 6, the determining unit 28 determines the order of processing for each of a plurality of regions in a group of images.

Subsequently, at step S15, the selector 30 selects one region from among the plurality of regions included in the group of images, according to the determined order of processing. Subsequently, at step S16, the encoder 32 encodes moving image data in the selected region, and thereby generates encoded data. Then, the encoder 32 outputs the generated encoded data to a unit at a subsequent stage.

When the encoding of the moving image data in the selected region has been completed, subsequently, at step S17, the selector 30 determines whether encoding of all regions in the group of images has been completed. If not completed (No at step S17), the selector 30 brings the process back to step S15 to select a region in the next turn in the order of processing. If completed (Yes at step S17), the selector 30 moves the process to step S18.

At step S18, the obtaining unit 22 determines whether the input of moving image data has been finished. If the input of moving image data has not been finished (No at step S18), the obtaining unit 22 brings the process back to step S11 to obtain the next group of images, and repeats the process from step S11. If the input of moving image data has been finished (Yes at step S18), the obtaining unit 22 ends the flow.

As described above, the encoding apparatus 100 according to the first embodiment encodes and outputs important regions earlier. By this, according to the encoding apparatus 100, even if a communication error occurs during transmission of encoded data, since an important part has been sent to an apparatus at a subsequent stage first, the possibility of being influenced by the communication error can be reduced. Therefore, according to the encoding apparatus 100, error-tolerant, high-quality encoded data can be outputted.

### Second Embodiment

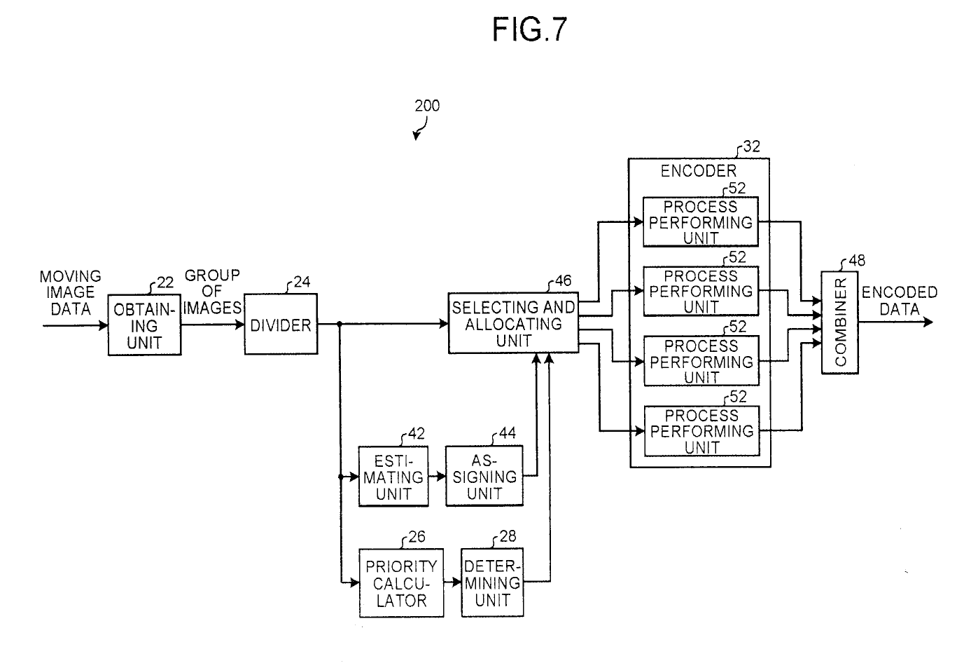

FIG. 7 is a block diagram of an encoding apparatus 200 according to a second embodiment. The encoding apparatus 200 according to the second embodiment has substantially the same functions and configurations as an encoding apparatus 100 according to the first embodiment whose overall configuration is illustrated in FIG. 1. Therefore, in the description of the encoding apparatus 200 according to the second embodiment, those units having substantially the same functions and configurations as those of the encoding apparatus 100 according to the first embodiment are denoted by the same reference signs and description thereof is omitted, except for differences.

The encoding apparatus 200 according to the second embodiment includes an obtaining unit 22, a divider 24, a priority calculator 26, a determining unit 28, an estimating unit 42, an assigning unit 44, a selecting and allocating unit 46, an encoder 32, and a combiner 48.

The encoder 32 according to the second embodiment has a plurality of process performing units 52 which operate in parallel with one another. The plurality of process performing units 52 each correspond to a core in a processor, and perform moving image data encoding processes by executing programs in parallel with one another. Note that although in the drawing four process performing units 52 are illustrated, the number of process performing units 52 included in the encoder 32 is not limited to four.

The estimating unit 42 estimates processing times for encoding of a respective plurality of regions. As an example, the estimating unit 42 estimates processing times for encoding, according to the complexity of encoding of the respective regions.

The assigning unit 44 assigns each of the plurality of regions to any one of the plurality of process performing units 52, according to the estimated processing times for the respective plurality of regions. More specifically, the assigning unit 44 assigns each of the plurality of regions included in the group of images to any one of the process performing units 52 such that there is a small difference in the total estimated processing time between the plurality of process performing units 52.

The selecting and allocating unit 46 allocates the plurality of regions divided by the divider 24 to the corresponding process performing units 52 assigned by the assigning unit 44. In this case, the selecting and allocating unit 46 selects the regions such that encoding is performed in the order according to the order of processing determined by the determining unit 28. More specifically, for example, the selecting and allocating unit 46 performs the following first or second process.

In the first process, the selecting and allocating unit 46 first divides the plurality of regions into groups for each process performing unit 52, according to the assignment performed by the assigning unit 44. Subsequently, the selecting and allocating unit 46 rearranges the regions in each group in the order according to the order of processing determined by the determining unit 28. Then, the selecting and allocating unit 46 allocates to each of the plurality of process performing units 52 the regions in a corresponding group in turn from the top region.

In the second process, the selecting and allocating unit 46 first rearranges all of the plurality of regions, according to the order of processing determined by the determining unit 28. Subsequently, while the selecting and allocating unit 46 holds the order obtained after the rearrangement, the selecting and allocating unit 46 divides the plurality of regions into groups for each process performing unit 52, according to the assignment performed by the assigning unit 44. Then, the selecting and allocating unit 46 allocates to each of the plurality of process performing units 52 the regions in a corresponding group in turn from the top region. Note that the same results are obtained for both of the case in which the regions are allocated by the first process and the case in which the regions are allocated by the second process.

Each of the plurality of process performing units 52 encodes the regions assigned thereto, in the order in which the regions are allocated by the selecting and allocating unit 46. Namely, each of the plurality of process performing units 52 encodes the regions assigned thereto by the assigning unit 44, in the order of processing determined by the determining unit 28. The combiner 48 multiplexes encoded data generated by the plurality of process performing units 52, and outputs the data to an apparatus at a subsequent stage.

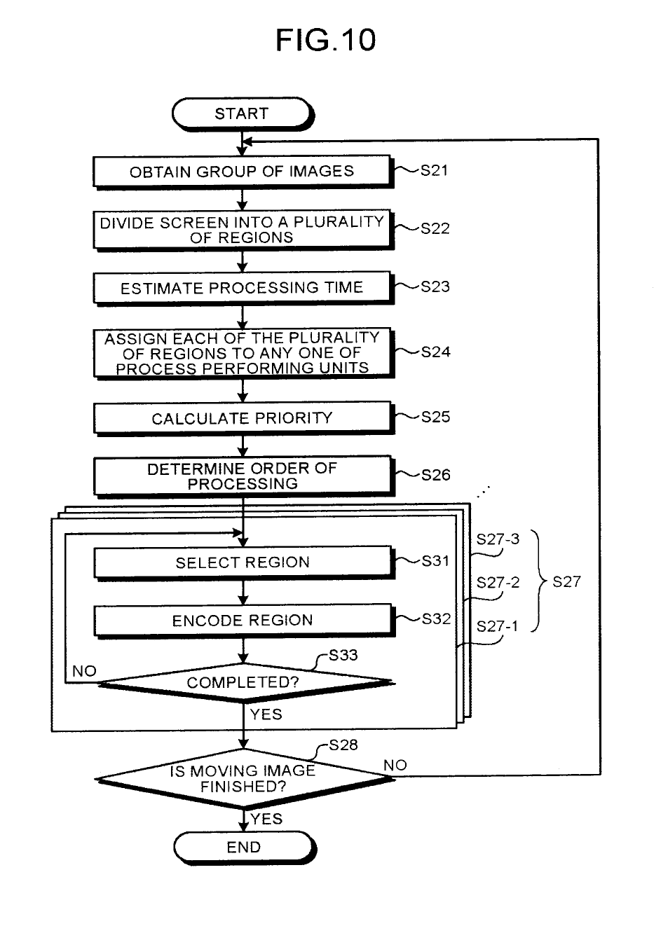

FIG. 10 is a flowchart illustrating the flow of a process performed by the encoding apparatus 200 according to the second embodiment. When input of moving image data starts, the encoding apparatus 200 starts the process from step S21.

First, at step S21, the obtaining unit 22 obtains a group of images from the moving image data. The process at step S21 is the same as that at step S11 of FIG. 2.

Subsequently, at step S22, the divider 24 divides each of the images included in the group of images into a plurality of regions. The process at step S22 is the same as that at step S12 of FIG. 2.

Subsequently, at step S23, the estimating unit 42 estimates processing times for encoding of the respective plurality of regions. As an example, the estimating unit 42 estimates processing times for encoding, according to the complexity of encoding of the respective regions.

The complexity of encoding is a parameter indicating how complex an encoding process for moving image data is to be. It is highly likely that the greater the complexity of encoding, the longer the time required to encode corresponding moving image data. The parameter indicating the complexity of encoding is, for example, activity. As an example, the estimating unit 42 calculates an estimated processing time, based on the magnitude of activity in a target region.

Furthermore, as an example, the estimating unit 42 may estimate a processing time for encoding of each of the plurality of regions, based on a processing time for encoding of the same region in the past encoding process. Since the change in image in a time direction is relatively small, by using a processing time for encoding of the same region, the estimating unit 42 can accurately estimate a processing time.

Subsequently, at step S24, the assigning unit 44 assigns each of the plurality of regions included in the group of images to any one of the plurality of process performing units 52 such that there is a small difference in the total estimated processing time between the plurality of process performing units 52.

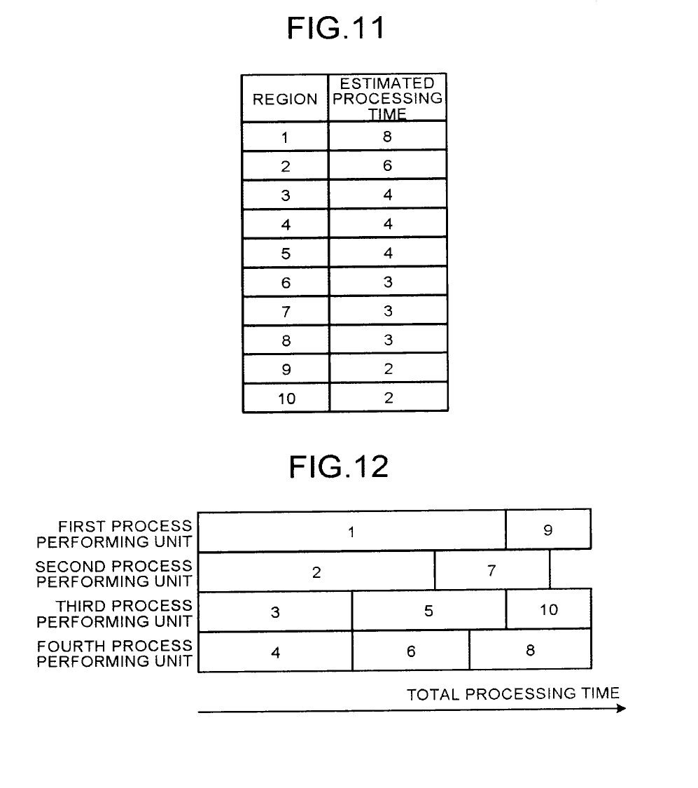

For example, it is assumed that the encoder 32 has four process performing units 52 and the number of regions included in one group of images is 10. It is assumed that estimated processing times for the respective regions are such as those illustrated in FIG. 11. Specifically, it is assumed that the estimated processing time for a first region is 8 unit time, the estimated processing time for a second region is 6 unit time, the estimated processing times for third to fifth regions are 4 unit time, the estimated processing times for sixth to eighth regions are 3 unit time, and the estimated processing times for ninth and tenth regions are 2 unit time.

In this case, for example, as illustrated in FIG. 12, the assigning unit 44 assigns the 10 regions to the four process performing units 52. Specifically, the assigning unit 44 assigns the first region and the ninth region to the first process performing unit 52. In addition, the assigning unit 44 assigns the second region and the seventh region to the second process performing unit 52. In addition, the assigning unit 44 assigns the third region, the fifth region, and the tenth region to the third process performing unit 52. In addition, the assigning unit 44 assigns the fourth region, the sixth region, and the eighth region to the fourth process performing unit 52. By this, the assigning unit 44 can assign each of the plurality of regions to any one of the process performing units 52 such that the total estimated processing times are substantially equal between the process performing units 52.

Subsequently, at step S25, the priority calculator 26 calculates priorities of the respective plurality of regions. The process at step S25 is the same as that at step S13 of FIG. 2. Note that the priority calculator 26 may perform the process at step S25 before step S23 or S24.

Subsequently, at step S26, the determining unit 28 determines, for each of the plurality of process performing units 52, the order of processing of the assigned regions, based on the priorities of the respective plurality of regions. In this case, the determining unit 28 determines the order of processing such that a region with a higher priority is given higher priority for being processed, i.e., processed in an earlier turn order. In addition, in this case, the determining unit 28 may obtain the estimated processing times for the regions from the estimating unit 42 and, for example, correct the order of processing such that a region with a longer estimated processing time is given higher priority for being encoded. By this, the determining unit 28 can determine the order of encoding such that a region with a large amount of information is given higher priority for being encoded.

Subsequently, at step S27 (S27-1, S27-2, and S27-3), the selecting and allocating unit 46 and the encoder 32 perform, for each of the plurality of process performing units 52, region selection and encoding processes in parallel with one another. Specifically, the selecting and allocating unit 46 and the encoder 32 perform steps S31, S32, and S33 in parallel during step S27.

At step S31, the selecting and allocating unit 46 selects one each from the regions assigned to the corresponding process performing units 52, according to the determined order of processing. Subsequently, at step S32, the corresponding process performing units 52 encode moving image data in the selected regions. Subsequently, at step S33, the selecting and allocating unit 46 determines whether encoding of all regions assigned to the corresponding process performing units 52 has been completed. If not completed (No at step S33), the selecting and allocating unit 46 brings the process back to step S31 to select regions in the next turn in the order of processing.

Then, in the selecting and allocating unit 46, if all of the process performing units 52 have completed encoding of all of the assigned regions (Yes at step S33), the selecting and allocating unit 46 moves the process to step S28.

Subsequently, at step S28, the obtaining unit 22 determines whether the input of moving image data has been finished. If the input of moving image data has not been finished (No at step S28), the obtaining unit 22 brings the process back to step S21 to obtain the next group of images, and repeats the process from step S21. If the input of moving image data has been finished (Yes at step S28), the obtaining unit 22 ends the flow.

As described above, the encoding apparatus 200 according to the second embodiment can make the processing times of the plurality of process performing units 52 substantially equal to each other. By this, according to the encoding apparatus 200, stop time where the process performing units 52 are not performing encoding processes is reduced, enabling to perform efficient operation. Therefore, according to the encoding apparatus 200, as in the first embodiment, error-tolerant, high-quality encoded data can be outputted and efficient operation can be performed.

Note that, when an error occurs in estimated processing time, a state may occur in which, while some of the plurality of process performing units 52 have completed encoding of all regions assigned thereto, other process performing units 52 have not completed encoding of regions assigned thereto. In the case of such a state, the assigning unit 44 may reassign a plurality of regions whose encoding has not been completed among the plurality of regions included in the group of images, to any of the process performing units 52 such that there is a small difference in the total estimated processing time between the plurality of process performing units 52. Furthermore, the determining unit 28 determines, for each of the plurality of process performing units 52, the order of processing of the assigned regions, based on the priorities of the respective plurality of regions whose encoding has not been completed.

Then, the selecting and allocating unit 46 and the encoder 32 perform, for each of the plurality of process performing units 52, selection and encoding processes for each of the plurality of regions whose encoding has not been completed. By performing such processes, the encoding apparatus 200 can more efficiently operate.

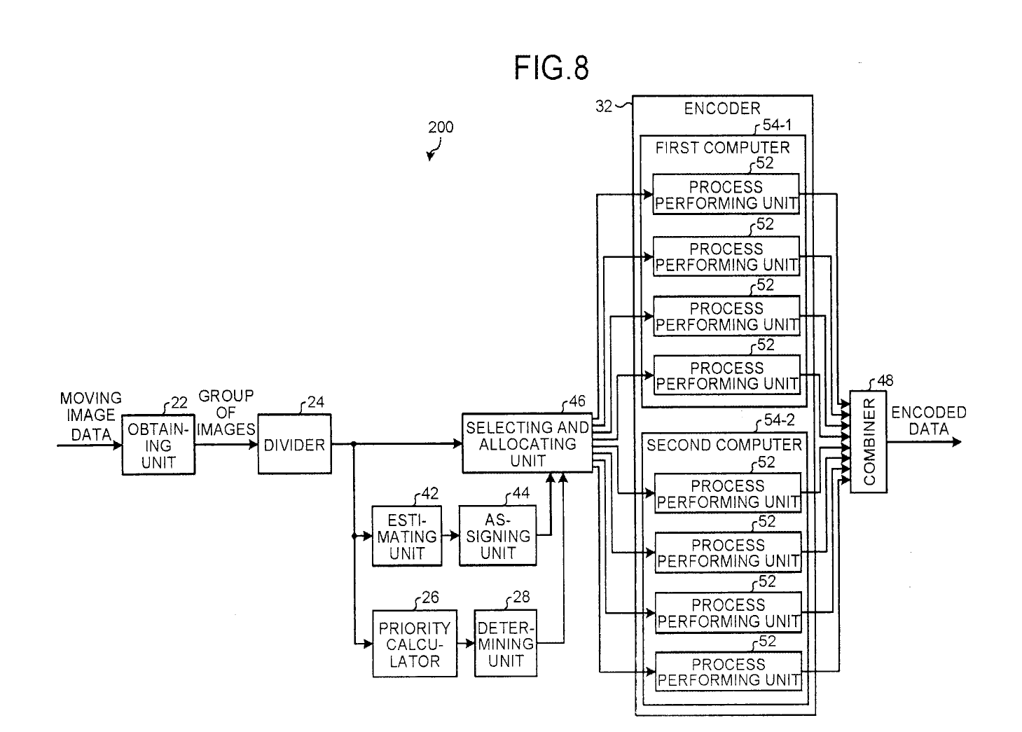

In addition, the plurality of process performing units 52 may be implemented by being distributed to processors of a plurality of different computers 54. For example, as illustrated in FIG. 8, a plurality of process performing units 52 may be implemented by being distributed to two computers, a first computer 54-1 and a second computer 54-2. Note that the number of computers 54 implementing the plurality of process performing units 52 in a distributed manner is not limited to two and may be three or more.

When the plurality of process performing units 52 are thus implemented by being distributed to the plurality of computers 54, the selecting and allocating unit 46 allocates regions such that each computer 54 encodes moving images on a set of groups of images basis. Here, a set of groups of images is a set including at least one group of images and is, for example, a GOP (Group Of Pictures) (e.g., a plurality of images between an I picture and an image immediately before the next I picture).

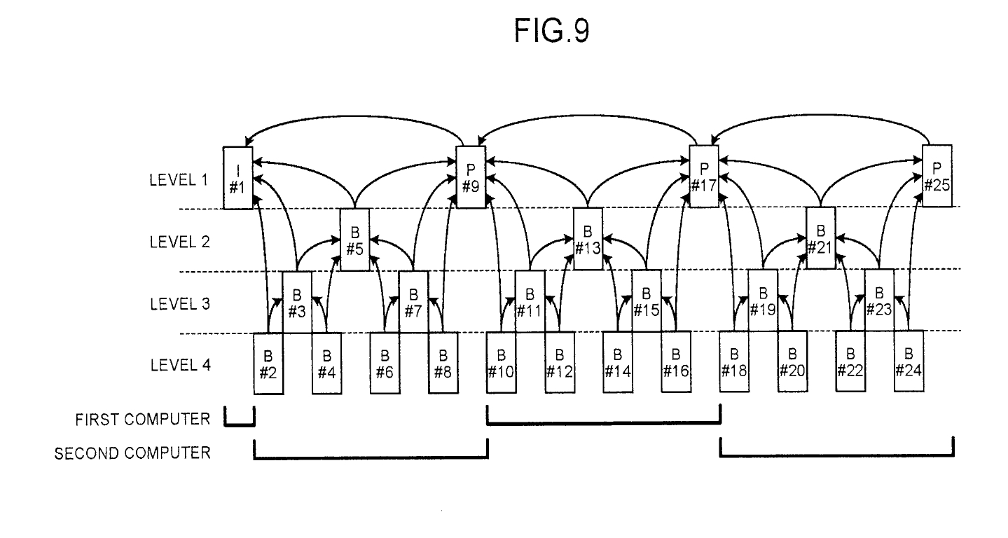

Alternatively, as an example, a set of groups of images may be a plurality of images delimited every occurrence of an image at the lowest level in the case of performing encoding using a multi-level hierarchical prediction structure (e.g., an image at level 1 in FIG. 9). For example, in the case of the hierarchical structure of FIG. 9, the selecting and allocating unit 46 divides moving image data into a set including an image #1, a set including images #2 to #9, a set including images #10 to #17, and a set including images #18 to #25. When the sets of groups of images divided in the above-described manner are allocated to the first computer 54-1 and the second computer 54-2 in a disturbed manner, the selecting and allocating unit 46 allocates, for example, the set of the image #1 and the set of the images #10 to #17 to the first computer 54-1. In addition, the selecting and allocating unit 46 allocates the set of the images #2 to #9 and the set of the images #18 to #25 to the second computer 54-2. Note that, when each of the plurality of computers 54 uses, as a reference image, an image encoded by the other computer 54, the computer 54 receives a copy of the required reference image from the other computer 54. By performing such a process, the encoding apparatus 200 can more efficiently perform a parallel encoding process.

### Third Embodiment

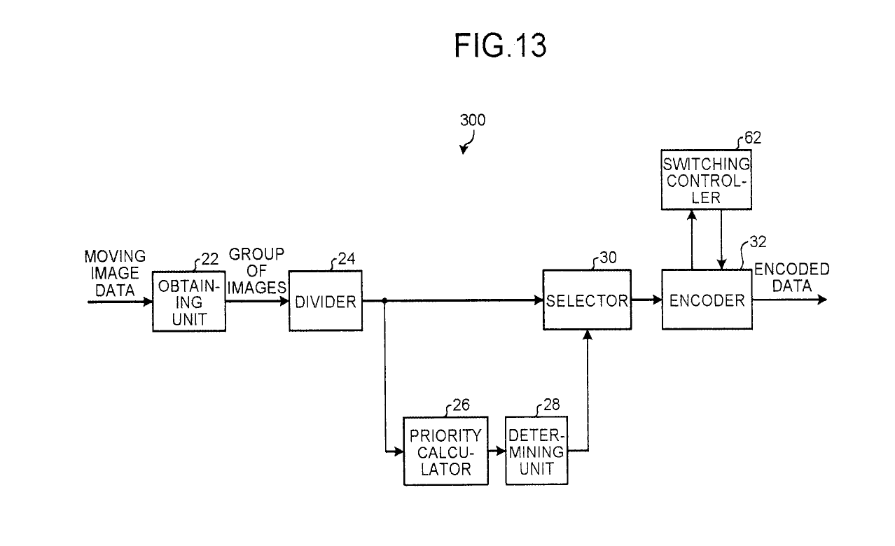

FIG. 13 is a block diagram of an encoding apparatus 300 according to a third embodiment. The encoding apparatus 300 according to the third embodiment has substantially the same functions and configurations as an encoding apparatus 100 according to the first embodiment whose overall configuration is illustrated in FIG. 1. Therefore, in the description of the encoding apparatus 300 according to the third embodiment, those units having substantially the same functions and configurations as those of the encoding apparatus 100 according to the first embodiment are denoted by the same reference signs and description thereof is omitted, except for differences.

The encoding apparatus 300 includes an obtaining unit 22, a divider 24, a priority calculator 26, a determining unit 28, a selector 30, an encoder 32, and a switching controller 62.

The switching controller 62 receives notification every time the encoder 32 completes encoding of moving image data in a predetermined unit, and measures a processing time for encoding of moving image data for each predetermined unit. Then, the switching controller 62 determines whether the processing time for encoding in the predetermined unit by the encoder 32 exceeds a predetermined reference time.

The predetermined unit is, for example, a group of images unit, an image unit, a region unit, an encoder smaller than regions, or the like. The reference time is, for example, a value according to the playback time of moving image data in a predetermined unit (e.g., 90% of the playback time of moving image data in a predetermined unit, etc.).

Then, when the processing time for encoding in the predetermined unit by the encoder 32 exceeds the predetermined reference time, the switching controller 62 switches the encoding scheme of the encoder 32 to a high-speed encoding scheme.

For example, when the frame rate is 60 frames/second and the number of regions in one frame is eight, encoding of one frame needs to be completed at 1/60 seconds or less and encoding of one region needs to be completed at 1/480 seconds. However, when encoding is performed in real time using a software program, the processing time for encoding may not be constant between frames, for example. Hence, when the processing time for encoding in the predetermined unit exceeds the reference time, the switching controller 62 switches the encoding scheme to a high-speed encoding scheme, by which the encoder 32 is allowed to ensure the real-time performance of encoding.

As an example, the switching controller 62 may switch the encoding scheme of the encoder 32 in a group of images unit. In this case, the switching controller 62 measures a processing time for encoding on a group of images basis. Then, when the processing time for encoding of a certain group of images exceeds the reference time, the switching controller 62 encodes a subsequent group of images using a high-speed encoding scheme.

Alternatively, as an example, the switching controller 62 may switch the encoding scheme of the encoder 32 in an image (frame or field) unit. In this case, the switching controller 62 measures a processing time for encoding on an image-by-image basis. Then, when the processing time for encoding of a certain image exceeds the reference time, the switching controller 62 encodes a subsequent image using a high-speed encoding scheme. By this, the switching controller 62 can make the processing times for each predetermined number of images constant.

Alternatively, as an example, the switching controller 62 may switch the encoding scheme of the encoder 32 in a region unit. In this case, the switching controller 62 measures a processing time for encoding on a region-by-region basis. Then, when the processing time for encoding of a certain region exceeds the reference time, the switching controller 62 encodes a subsequent region using a high-speed encoding scheme. By this, the switching controller 62 can make the processing times for each image constant.

Alternatively, as an example, the switching controller 62 may switch the encoding scheme of the encoder 32 in a unit smaller than regions (e.g., a macroblock or coding unit unit). In this case, the switching controller 62 measures a processing time for encoding on an encoder basis smaller than regions. Then, when the processing time for encoding of the encoder smaller than regions exceeds the reference time, the switching controller 62 encodes a subsequent encoder using a high-speed encoding scheme. By this, the switching controller 62 can make the processing times for regions, for example, constant.

In addition, the switching controller 62 may switch the encoding scheme for the next predetermined unit to a high-speed scheme immediately after the processing time for encoding of a predetermined unit exceeds the reference time. For example, the switching controller 62 may switch the encoding scheme for a subsequent predetermined unit to a high-speed scheme after the processing times for a plurality of predetermined units continuously exceed the reference time. In addition, when the processing time for encoding of a predetermined unit is significantly shorter than the reference time, the switching controller 62 may switch the encoding scheme for a subsequent predetermined unit to a scheme with a large amount of computation.

The switching controller 62 may switch the scheme to any scheme as long as the processing time for encoding can be reduced. As an example, the switching controller 62 increases the speed of an encoding process by narrowing a motion vector search range, or reducing the accuracy of motion vector search, or reducing the number of encoding modes to be used, or simplifying mode determination cost computation, or disabling a loop filter. Alternatively, the switching controller 62 may increase the speed of an encoding process by performing the process of replacing all macroblocks by a pre-registered encoded stream.

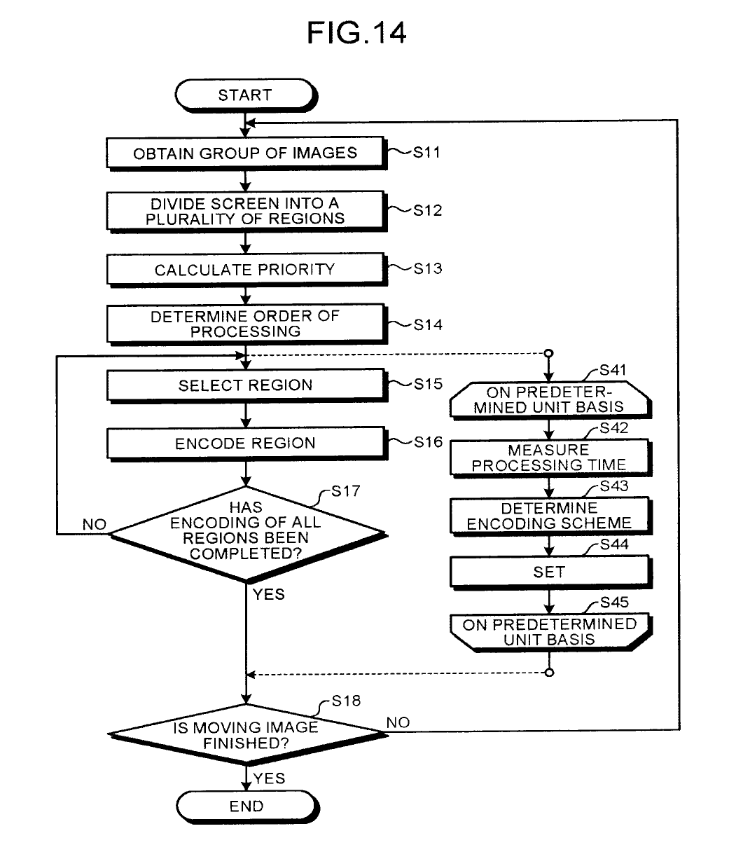

FIG. 14 is a flowchart illustrating the flow of a process performed by the encoding apparatus 300 according to the third embodiment. The encoding apparatus 300 performs the processes at steps S11 to S18 in the same manner as the processes illustrated in the flowchart of FIG. 2.

The encoding apparatus 300 repeatedly performs processes between steps S41 and S45 on a predetermined unit of moving image data basis (a loop process between steps S41 and S45), in parallel with the processes at steps S11 to S18.

In the loop process, first, at step S42, the switching controller 62 measures a processing time for encoding of moving image data. Subsequently, at step S43, the switching controller 62 determines an encoding scheme, based on the measured processing time. At step S44, the switching controller 62 sets the determined encoding scheme for the encoder 32. Then, the switching controller 62 repeatedly performs the above-described loop process until moving image data is finished.

As described above, the encoding apparatus 300 according to the third embodiment can switch the encoding scheme to a high-speed encoding scheme when the processing time for encoding exceeds the reference time. By this, according to the encoding apparatus 300, encoding can be performed in real time by, for example, making the processing times for encoding for each group of images, each image, or each region equal. In addition, even if the encoding apparatus 300 switches the encoding scheme to a high-speed encoding scheme, since important regions have been encoded first, the encoding apparatus 300 can increase the quality of encoded data. Therefore, according to the encoding apparatus 300, high-quality encoded data can be outputted and the real-time performance of encoding can be ensured.

Note that the switching controller 62 of the encoding apparatus 300 according to the third embodiment may be provided in an encoding apparatus 200 according to the second embodiment. For example, the encoding apparatus 200 according to the second embodiment may include a plurality of switching controllers 62 for a respective plurality of process performing units 52. In this case, the plurality of switching controllers 62 control the encoding schemes of the corresponding process performing units 52. Alternatively, the encoding apparatus 200 according to the second embodiment may include one switching controller 62. In this case, the switching controller 62 collectively controls the encoding schemes of the plurality of process performing units 52. Such an encoding apparatus 200 according to the second embodiment can output high-quality encoded data and can efficiently operate in real time.

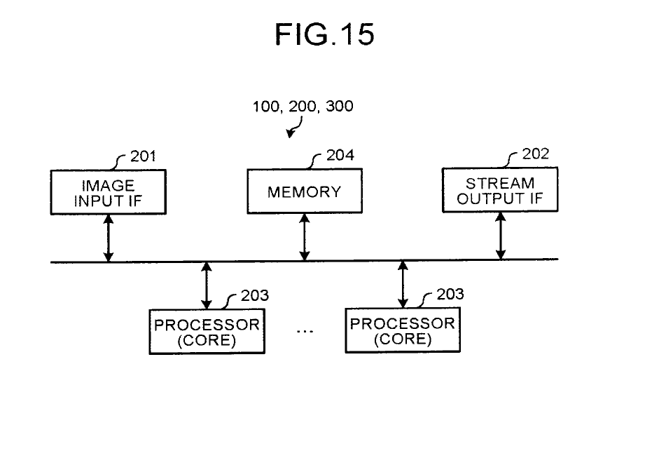

FIG. 15 is a diagram illustrating an example of a hardware configuration of the encoding apparatuses 100, 200, and 300 according to the first to third embodiments. In the encoding apparatuses 100, 200, and 300 according to the first to third embodiments, a general-purpose computer can be implemented as basic hardware. In this case, the computer functions as the encoding apparatus 100, 200, or 300 by executing a pre-installed encoding program.

The computer that executes the encoding program includes, for example, an image input IF 201 that accepts, as input, moving image data from an external source; a stream output IF 202 that outputs encoded data to an external source; a plurality of processors 203 which are CPU (Central Processing Unit) cores, etc.; and a memory 204 such as a ROM (Read Only Memory) and a RAM (Random Access Memory). The image input IF 201, the stream output IF 202, the plurality of processors 203, and the memory 204 are connected to each other through a bus, etc.

Programs executed by the encoding apparatuses 100, 200, and 300 according to the embodiments are provided, for example, pre-installed in the ROM, etc. In addition, the programs executed by the encoding apparatuses 100, 200, and 300 according to the embodiments may be configured to be provided as computer program products by recording the programs in a computer-readable recording medium, such as a CD-ROM (Compact Disk Read Only Memory), a flexible disk (FD), a CD-R (Compact Disk Recordable), or a DVD (Digital Versatile Disk), in an installable or executable format file.

Furthermore, the programs executed by the encoding apparatuses 100, 200, and 300 according to the embodiments may be configured to be provided by storing the programs on a computer connected to a network such as the Internet, and downloading the programs via the network. Alternatively, the programs executed by the encoding apparatuses 100, 200, and 300 according to the embodiments may be configured to be provided or distributed via a network such as the Internet.

The program executed by the encoding apparatus 100 according to the first embodiment includes an obtaining module, a dividing module, a priority calculating module, a determining module, a selecting module, and an encoding module. The program can cause a computer to function as the above-described units of the encoding apparatus 100 (the obtaining unit 22, the divider 24, the priority calculator 26, the determining unit 28, the selector 30, and the encoder 32). Note that, in the computer, a processor 203 can read the program from a computer-readable storage medium into a main storage apparatus and execute the program. In addition, some or all of the obtaining unit 22, the divider 24, the priority calculator 26, the determining unit 28, the selector 30, and the encoder 32 may be configured or may be implemented by hardware such as a circuit. In addition, the computer functioning as the encoding apparatus 100 according to the first embodiment includes at least one processor 203.

In addition, the program executed by the encoding apparatus 200 according to the second embodiment includes an obtaining module, a dividing module, an estimating module, an assigning module, a priority calculating module, a determining module, a selecting and allocating module, an encoding module having a plurality of process performing modules, and a combining module. The program can cause a computer including a plurality of processors 203 to function as the above-described units of the encoding apparatus 200 (the obtaining unit 22, the divider 24, the estimating unit 42, the assigning unit 44, the priority calculator 26, the determining unit 28, the selecting and allocating unit 46, the encoder 32 having the plurality of process performing units 52, and the combiner 48). Note that, in the computer, each processor 203 can read the program from a computer-readable storage medium into a main storage apparatus and execute the program. In addition, some or all of the obtaining unit 22, the divider 24, the estimating unit 42, the assigning unit 44, the priority calculator 26, the determining unit 28, the selecting and allocating unit 46, the encoder 32, and the combiner 48 may be configured or may be implemented by hardware such as a circuit.

In addition, the program executed by the encoding apparatus 300 according to the third embodiment includes an obtaining module, a dividing module, a priority calculating module, a determining module, a selecting module, a switching control module, and an encoding module. The program can cause a computer to function as the above-described units of the encoding apparatus 300 (the obtaining unit 22, the divider 24, the priority calculator 26, the determining unit 28, the selector 30, the switching controller 62, and the encoder 32). Note that, in the computer, a processor 203 can read the program from a computer-readable storage medium into a main storage apparatus and execute the program. In addition, some or all of the obtaining unit 22, the divider 24, the priority calculator 26, the determining unit 28, the selector 30, the switching controller 62, and the encoder 32 may be configured or may be implemented by hardware such as a circuit. In addition, the computer functioning as the encoding apparatus 300 according to the third embodiment includes at least one processor 203.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An encoding apparatus comprising:
a processor; and
a memory that stores processor-executable instructions that, when executed by the processor, cause the processor to:
divide an image included in an image group into a plurality of regions;
calculate a priority for each of the regions on the basis of levels of importance of the regions;
determine an order of processing for the regions on the basis of the corresponding priority; and
encode the regions according to the determined order of processing.

2. The apparatus according to claim 1, wherein
the processor includes a plurality of process performing units that encode the region assigned thereto in the determined order of processing; and
the processor further performs:
estimating processing times for encoding of each of the regions; and
assigning each of the regions to any one of the process performing units according to corresponding estimated processing time for the region.

3. The apparatus according to claim 2, wherein the processor further performs:
assigning each of the regions to any one of the process performing units such that there is a small difference in total estimated processing time between the process performing units.

4. The apparatus according to claim 3, wherein the processor further performs:
determining an order of encoding for each process performing unit such that a region with a longer estimated processing time is given higher priority for being encoded.

5. The apparatus according to claim 1, wherein the processor further performs:
calculating the priority on the basis of at least one of levels of importance including whether the region is a reference image, a feature of the region, and a position in the image.

6. The apparatus according to claim 1, wherein the processor further performs:
switching an encoding scheme of the encoder to a high-speed encoding scheme when a processing time for encoding by the encoder exceeds a predetermined reference time.

7. The apparatus according to claim 6, wherein the processor further performs:
switching the encoding scheme of the encoder in an image group unit.

8. The apparatus according to claim 6, wherein the processor further performs:
switching the encoding scheme of the encoder in a region unit.

9. The apparatus according to claim 6, wherein the processor further performs:
switching the encoding scheme of the encoder in a unit smaller than the region unit.

10. The apparatus according to claim 1, wherein the processor further performs:
obtaining a group of images including a plurality of images with the images having no reference relationship therebetween; and
dividing each image included in the obtained group of images into a plurality of regions.

11. The apparatus according to claim 1, wherein the processor further performs:
dividing a screen for the image into slice units of a moving image encoding standard scheme.

12. The apparatus according to claim 1, wherein the processor further performs:
dividing a screen for the image into tile units of MPEG-H HEVC/H.265.

13. The apparatus according to claim 1, wherein the processor further performs:
calculating the priority on the basis of whether the region is foreground or background.

14. The apparatus according to claim 1, wherein the processor further performs:
calculating the priority on the basis of activity in the region.

15. The apparatus according to claim 1, wherein the processor further performs:
calculating the priority on the basis of an amount of movement in the region.

16. The apparatus according to claim 2, wherein the processor further performs:
estimating the processing time for encoding of each of the regions on the basis of a processing time for encoding of a same region in a past encoding process.

17. An encoding method comprising:
dividing an image included in an image group into a plurality of regions;
calculating a priority for each of the regions on the basis of levels of importance of the regions;
determining an order of processing for the regions on the basis of the corresponding priority; and
encoding the regions according to the determined order of processing.

18. An encoding apparatus comprising:
a circuitry that divides an image included in an image group into a plurality of regions;
a circuitry that calculates a priority for each of the regions on the basis of levels of importance of the regions;
a circuitry that determines an order of processing for the regions on the basis of the corresponding priority; and
a circuitry that encodes the regions according to the determined order of processing.
